(19) United States
(12) Patent Application Publication
(10) Pub. No.: US 2026/0093466 A1
(43) Pub. Date: Apr. 2, 2026

(54) SYSTEMS AND METHODS FOR AUTOMATED LAMBDA DISCOVERY AND INSTRUCTION GENERATION

(71) Applicant: Protiviti Inc., Menlo Park, CA (US)

(72) Inventor: John Michael DuBois, Pleasant Grove, UT (US)

(73) Assignee: Protiviti Inc., Menlo Park, CA (US)

(21) Appl. No.: 19/193,424

(22) Filed: Apr. 29, 2025

Related U.S. Application Data
(60) Provisional application No. 63/702,430, filed on Oct. 2, 2024.

(51) Int. Cl. G06F 8/41

(52) U.S. Cl. CPC G06F 8/4441; G06F 8/42

(57) ABSTRACT

Automated lambda discovery and instruction generation is provided. A method includes receiving an abstract syntax tree (AST) of a set of executable instructions in a first programming language. The method includes identifying, using the AST, one or more loops represented by the AST for the set of executable instructions. The method includes identifying, for each of the one or more loops, a count of a number of variables referenced or assigned for each of the one or more loops. The method includes determining, for a loop of the one or more loops, that the count meets a threshold for which to generate a lambda expression in a second programming language for the loop. The method includes generating, based at least on the determination, a second set of executable instructions in the second programming language including the lambda expression to represent the loop.

### CROSS REFERENCE TO RELATED APPLICATION

This application claims the benefit of, and priority to, U.S. Provisional Application No. 63/702,430, filed on Oct. 2, 2024, which is incorporated by reference herein in its entirety for all purposes.

### FIELD OF THE DISCLOSURE

This disclosure generally relates to systems and methods for automated lambda discovery and instruction generation. For example, the disclosure relates to trans-compiling instructions using an abstract syntax tree (AST).

### BACKGROUND OF THE DISCLOSURE

Organizations sometimes maintain legacy codebases that have accumulated over years, or even decades, of software development. These older codebases are often critical to the operation of core systems, but they may use outdated technologies, languages, and architectures. While these systems continue to function, updating or replacing them can be expensive and risky, leading many organizations to continue relying on them. However, this also makes it harder to integrate with modern tools or development practices, and maintaining a large, older codebase can be a significant drain on resources.

Security and maintenance risks associated with legacy programs are substantial. Older code may not have been developed with current security best practices in mind, making it more vulnerable to cyberattacks or exploits. Additionally, maintaining such systems can become more difficult over time, as the original developers may no longer be available, and modern developers may struggle to understand the code due to outdated or poorly documented structures. Unpatched vulnerabilities, deprecated dependencies, and the lack of updates can expose organizations to operational disruptions.

### BRIEF SUMMARY OF THE DISCLOSURE

The present disclosure provides systems and methods for automated lambda expression discovery and instruction generation. A data processing system can receive source files of a first language, as may lack lambda expressions instruction structures. The data processing system can generate an abstract syntax tree (AST) to co-relate instructions of the source files to one another. The data processing system can apply language rules to the AST. For example, the data processing system can determine metrics, such as a number of variable assignments or references within loop structures of the instructions in the source files. The metrics can further correspond to syntax of the source files. For example, a presence of lambda expressions (or lambda-like expressions such as anonymous functions or function pointers) can be evaluated to determine configuration criteria of an output file. The data processing system can compare the various metrics to one or more corresponding thresholds to identify instructions of the source files compatible with lambda expression implementations. The data processing system can generate language for an output file in a second language using the language rules, the output file to include lambda expressions for the identified loops where found to be compatible.

In some aspects, this disclosure is directed to a system including one or more processors coupled with memory. The one or more processors can receive an abstract syntax tree (AST) of a set of executable instructions in a first programming language. The one or more processors can identify, using the AST, one or more loops represented by the AST for the set of executable instructions. The one or more processors can identify, for each of the one or more loops, a count of a number of variables referenced or assigned for each of the one or more loops. The one or more processors can determine, for a loop of the one or more loops, that the count meets a threshold for which to generate a lambda expression in a second programming language for the loop. The one or more processors can generate, by the one or more processors based at least on the determination, a second set of executable instructions in the second programming language including the lambda expression to represent the loop.

In some embodiments, the one or more processors are configured to create a flat version of the AST and use the flat version of the AST to identify the one or more loops. In some embodiments, the threshold is determined based at least on a type of the second programming language. In some embodiments, the one or more processors are further configured to determine whether each loop of the one or more loops is a latent loop (e.g., a loop which is not identified by the presence of a looping command keyword such as loop, for, or while) or is identified by a loop construct of the first programming language. In some embodiments, the threshold is determined based at least on whether the loop is the latent loop or is identified by the loop construct. In some embodiments, the one or more processors are further configured to decorate a loop head in the AST upon identifying the one or more loops, the decoration including an indication of a loop type of a plurality of loop types, wherein the generation of the lambda expression is based at least on the loop type. In some embodiments, the count includes a number of variable assignments. In some embodiments, the count includes a number of variable references.

In some aspects, this disclosure is directed to a method. The method includes receiving, by one or more processors, an abstract syntax tree (AST) of a set of executable instructions in a first programming language. The method includes identifying, by the one or more processors using the AST, one or more loops represented by the AST for the set of executable instructions. The method includes identifying, by the one or more processors for each of the one or more loops, a count of a number of variables referenced or assigned for each of the one or more loops. The method includes determining, by the one or more processors for a loop of the one or more loops, that the count meets a threshold for which to generate a lambda expression in a second programming language for the loop. The method includes generating, by the one or more processors based at least on the determination, a second set of executable instructions in the second programming language including the lambda expression to represent the loop.

In some embodiments, the method includes creating a flat version of the AST and using the flat version of the AST to identify the one or more loops. In some embodiments, the threshold is determined based at least on a type of the second programming language. In some embodiments, the method includes determining, by the one or more processors, whether each loop of the one or more loops is a latent loop or is identified by a loop construct of the first programming language. In some embodiments, the threshold is determined based at least on whether the loop is the latent loop or is identified by the loop construct. In some embodiments, the method includes decorating a loop head in the AST upon identifying the one or more loops, the decoration including an indication of a loop type of a plurality of loop types, wherein the generation of the lambda expression is based at least on the loop type. In some embodiments, the threshold includes a threshold number of variable assignments. In some embodiments, the threshold includes a threshold number of variable assignments.

In some aspects, this disclosure is directed to a non-transitory computer-readable medium including computer-readable instructions stored thereon configured for execution by one or more processors of a data processing system. The instructions can include instructions to create a flat version of a received abstract syntax tree (AST) of a set of executable instructions in a first programming language. The instructions can include instructions to identify, using the flat version of the AST, one or more loops represented by the AST for the set of executable instructions. The instructions can include instructions to identify, for each of the one or more loops, a count of a number of variables referenced or assigned for each of the one or more loops. The instructions can include instructions to determine, for a loop of the one or more loops, that the count meets a threshold for which to generate a lambda expression in a second programming language for the loop. The instructions can include instructions to generate, by the one or more processors based at least on the determination, a second set of executable instructions in the second programming language including the lambda expression to represent the loop.

In some embodiments, the computer-readable instructions include instructions to determine whether each loop of the one or more loops is a latent loop or is identified by a loop construct of the first programming language, wherein the threshold is determined based at least on whether the loop is the latent loop or is identified by the loop construct. In some embodiments, the threshold is determined based at least on a type of the second programming language. In some embodiments, the count includes a number of variable assignments and a number of variable references.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client device in communication with server device;

FIG. 1B is a block diagram depicting a cloud computing environment comprising client device in communication with cloud service providers;

FIGS. 1C and 1D are block diagrams depicting embodiments of computing devices useful in connection with the methods and systems described herein.

FIG. 2 is a block diagram depicting a data processing system, in accordance with some embodiments.

FIG. 3A is a block diagram depicting a first portion of a method of functional derivation of computer-executable code, in accordance with some embodiments.

FIG. 3B is a block diagram depicting a second portion of the method of functional derivation of computer-executable code, in accordance with some embodiments.

FIG. 3C is a block diagram depicting a third portion of the method of functional derivation of computer-executable code, in accordance with some embodiments.

FIG. 4 is a structured abstract syntax tree corresponding to a code structure of computer executable instructions, in accordance with some embodiments.

### DETAILED DESCRIPTION

For purposes of reading the description of the various embodiments below, the following descriptions of the sections of the specification and their respective contents may be helpful:

Section A describes a network environment and computing environment which may be useful for practicing embodiments described herein.

Section B describes embodiments of systems and methods for automated functional derivation and translation of computer-executable code.

### A. Computing and Network Environment

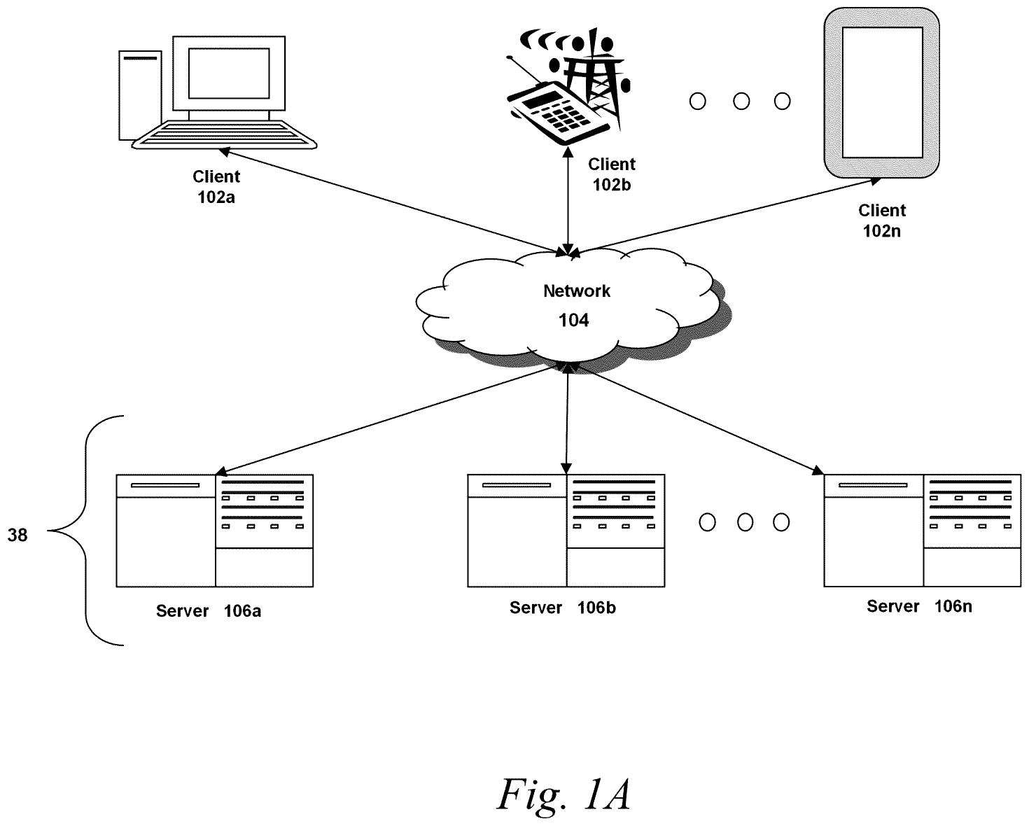

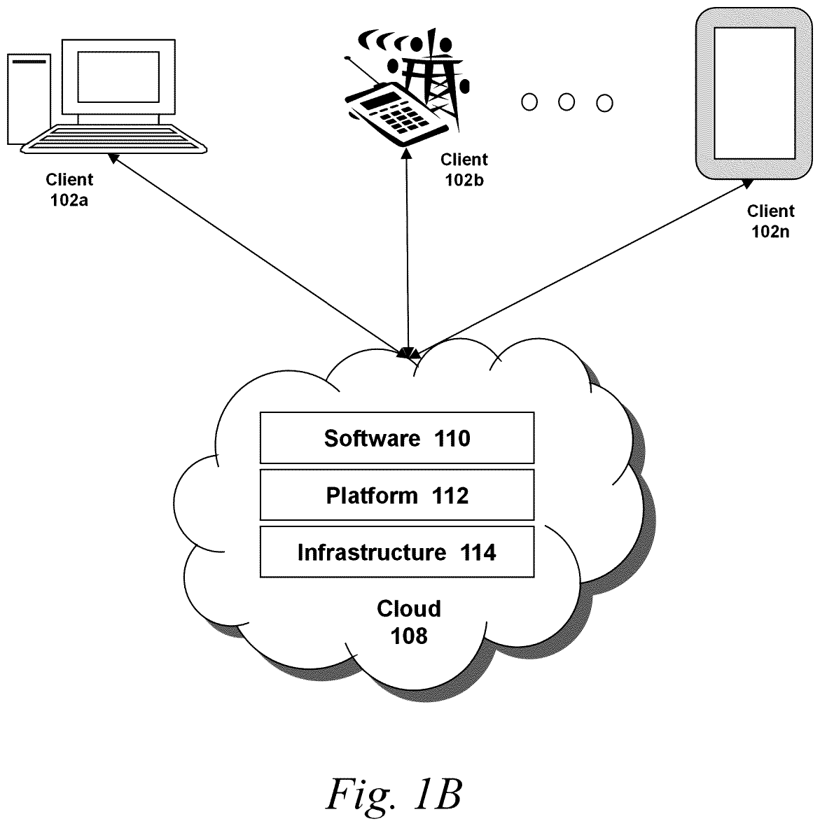

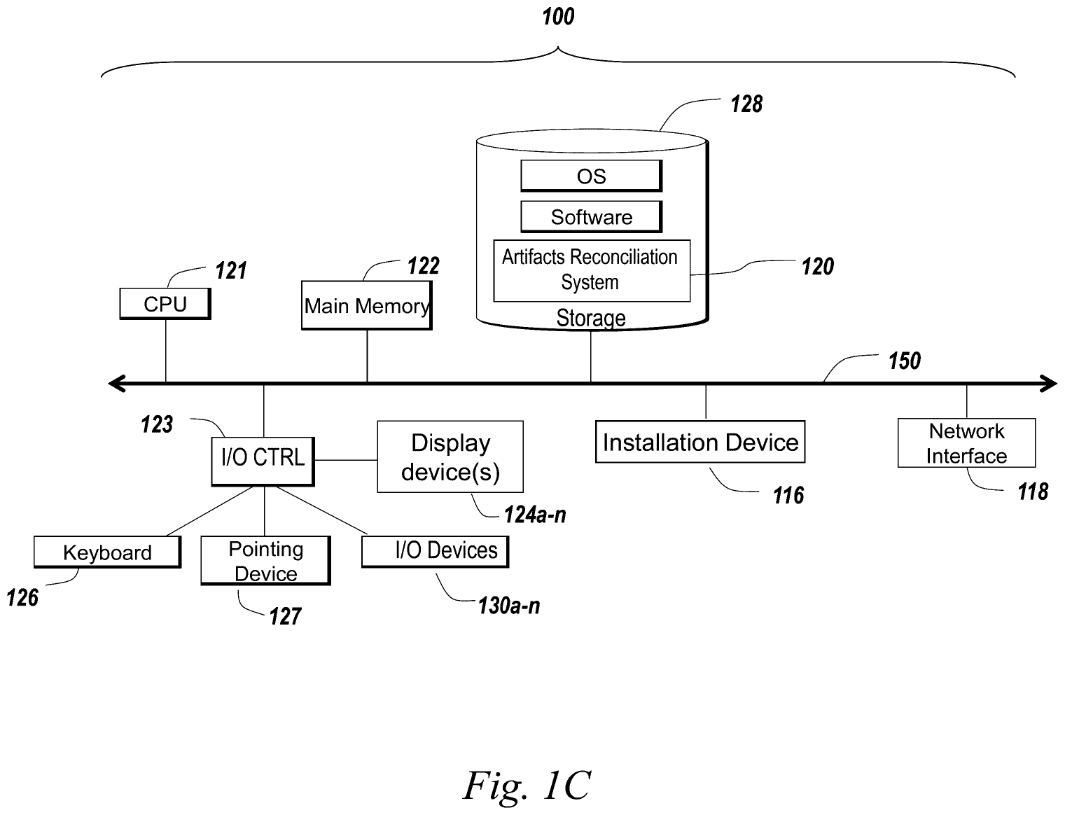

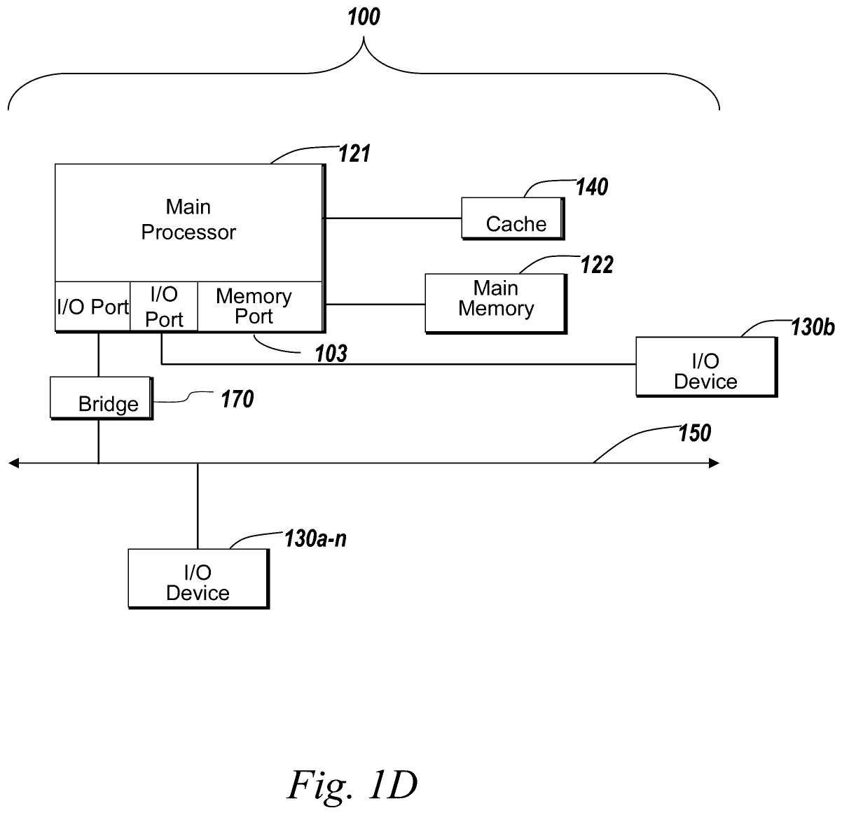

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous-one or more of the servers 106 or machines 106 can operate according to one type of operating system platform (e.g., WINDOWS NT, manufactured by Microsoft Corp. of Redmond, Washington), while one or more of the other servers 106 can operate on according to another type of operating system platform (e.g., Unix, Linux, or Mac OS X).

In some embodiments, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, of Palo Alto, California; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In some embodiments, the server 106 may be referred to as a remote machine or a node. In another embodiment, a plurality of nodes 106 may be in the path between any two communicating servers.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud based delivery, e.g. Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, or Google Compute Engine provided by Google of Mountain View, California. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google, and HEROKU provided by Heroku, Inc. of San Francisco, California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google, SALESFORCE provided by Salesforce Inc. of San Francisco, California, or OFFICE 365 provided by Microsoft Corporation. Examples of SaaS may also include data storage providers, e.g. DROPBOX provided by Dropbox, Inc. of San Francisco, California, Microsoft SKYDRIVE provided by Microsoft Corporation, Google Drive provided by Google, or Apple ICLOUD provided by Apple Inc. of Cupertino, California.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, California). Clients 102 may also access SaaS resources through smartphone or tablet applications, including, e.g., Salesforce Sales Cloud, or Google Drive app. Clients 102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g. a mouse. The storage device 128 may include, without limitation, an operating system, software, and a software of a data processing system 205. As shown in FIG. 1D, each computing device 100 may also include additional optional elements, e.g. a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, California; those manufactured by Motorola Corporation of Schaumburg, Illinois; the ARM processor and TEGRA system on a chip (SoC) manufactured by Nvidia of Santa Clara, California; the POWER7 processor, those manufactured by International Business Machines of White Plains, New York; or those manufactured by Advanced Micro Devices of Sunnyvale, California. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of a multi-core processors include the AMD PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple IPHONE. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augment reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g. a USB bus, a SCSI bus, a Fire Wire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In some embodiments, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in some embodiments, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related to the software 120 for the experiment tracker system. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via a I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as an installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google, Chrome Webstore for CHROME OS provided by Google, and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In some embodiments, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Florida. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Washington; MAC OS and iOS, manufactured by Apple, Inc. of Cupertino, California; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, California, among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Washington.

In some embodiments, the computing device 100 is a digital audio player such as the Apple IPOD, IPOD Touch, and IPOD NANO lines of devices, manufactured by Apple Computer of Cupertino, California. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Washington. In other embodiments, the computing device 100 is an eBook reader, e.g. the KINDLE family of devices by Amazon.com, or NOOK family of devices by Barnes & Noble, Inc. of New York City, New York.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In some of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Automated Functional Derivation and Translation

Lambda expressions (sometimes referred to as anonymous functions) have become a feature in many programming languages, playing a role in functional programming paradigms. lambda expressions aid developers to create concise, function-like constructs that can be passed as arguments, returned from functions, or stored in variables. The prevalence of lambda expressions has significantly increased in languages such as Java, Python, and C++, underlining the benefits of efficient handling of these constructs in compilers.

In some compiler designs, control flow analysis focuses on the identification and optimization of named functions and procedures. However, lambda expressions introduce additional complexity due to their dynamic nature and the possibility of being defined and invoked at runtime. These anonymous functions can capture variables from their surrounding environment, interact with closures, and significantly impact the overall control flow of a program. Consequently, systems and methods to accurately discover and manage lambda expressions may prove useful. For example, some embodiments of the present disclosure can apply the various techniques provided herein during the control flow analysis phase of a compiler or other code generator.

The use of lambda expressions can relative performant advantages. For example, some lambda expressions (e.g., non-capturing lambda expressions) may be stack allocated or in-lined, relative to other structures which may be heap allocated. Moreover, the use of lambda expressions can aid the operation of run-time branch predictors. Further, the use of lambda expressions can improve code readability, or otherwise conform to coding guidelines. Identification of control flow and computations in some programming languages that lack lambda function syntax can be performed in the context of translation of a historical codebase to a language supporting lambda expressions.

Novel systems and methods for the identification of loop structures expressible as lambda expressions within the control flow of a program are provided according to the present disclosure. Various implementations of these systems and methods can aid compilers to generate functional constructs more effectively. The provided approach can leverage static analysis techniques to identify the presence of loop structures expressible as lambda expressions, map their scope and closure properties, and integrate them into the program's control flow graph (CFG). By doing so, the systems and methods can aid optimization operations such as inlining, dead code elimination, and more effective resource management for closures. The loop structures expressible as lambda expressions can be identified according to various metrics, as may relate to a number of memory access events or to readability of resultant code (e.g., a number of variable assignments or references).

Various thresholds corresponding to the metrics can include fixed or configurable thresholds. For example, the thresholds can be received as configurable parameters, as may vary according to a user selection, an input language, a target language, a processor or memory architecture of a device configured to execute the codebase in the target language, or other aspects of the present disclosure. In some embodiments, the thresholds can be determined according to an application of heuristics that depend, at least in part, on executable logic of instructions received in an input file. For example, thresholds can be scaled up or down in response to a number of lambda expression outputs that would result from their application. Such a dynamic approach can avoid over or under-use of lambda expressions in instructions generated according to the present disclosure.

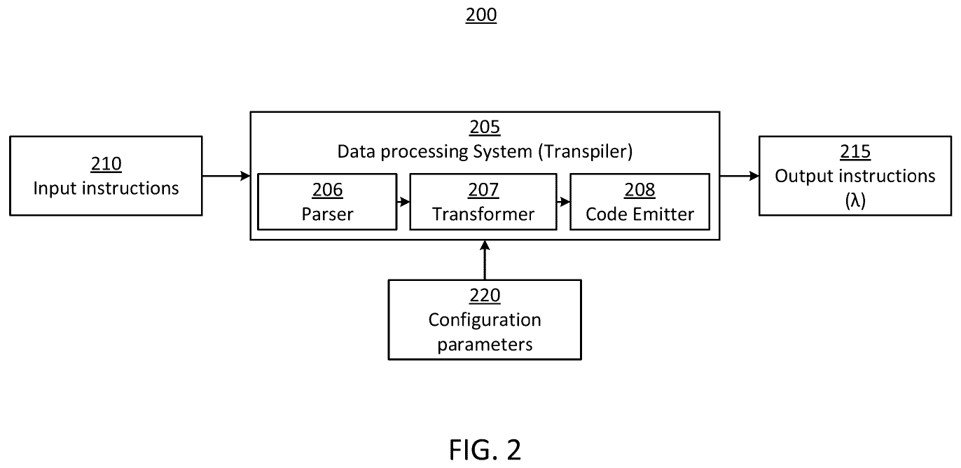

Referring to FIG. 2, a functional block diagram 200 of a data processing system 205 is provided, according to some embodiments of the present disclosure. The data processing system 205 can receive input instructions 210. The input instructions 210 can include executable instructions in a first programming language, sometimes referred to as a source language. The first programming language can include various legacy languages, instructions which have not undergone linting (e.g., automated analysis of functional or stylistic issues), or any other instruction sets provided to the data processing system 205. The input instructions 210 can refer to instructions received according to various levels of a language. For example, the input instructions 210 can be received as a user level language (sometimes referred to as a “high-level” language as can include C, COBOL, FORTRAN), assembly code, machine code, or so forth.

The data processing system 205 can receive input instructions 210 including a function implementing a loop structure. The input instructions 210 can include numerous further instructions, such that maintaining or reading the code can become challenging. For example, the input instructions 210 can include hundreds or thousands of further loops structures. An illustrative example of one loop structure, as may be received in the input instructions 210, is provided below, according to a COBOL source language (e.g., to update a COBOL codebase to another language). The depicted example receives a series of numbers and computes their algebraic squares.

### Example 1

```
MOVE 1 TO VALUE-NUMBER(1)
MOVE 2 TO VALUE-NUMBER(2)
MOVE 3 TO VALUE-NUMBER(3)
MOVE 4 TO VALUE-NUMBER(4)
PERFORM VARYING I FROM 1 BY 1 UNTIL I > 4
  COMPUTE VALUE-SQUARE(I) = VALUE-NUMBER(I) *
  VALUE-NUMBER(I)
END-PERFORM
```

The above-depicted example includes a COBOL loop construct in the form of “WHILE VARYING;” further languages can include other loop constructs such as “for,” “while,” or “loop.” The data processing system 205 can identify some loops from the presence of the loop constructs. However, some loops encoded in input instructions 210 can include latent loops which do not necessarily include a loop construct. For example, various control transfer instructions (e.g., jump, branch, GOTO) can form functional loops without using a loop construct appropriate to a language of the input instructions 210. Moreover, some loop constructs included in the input instructions 210 may not implement loops. For example, a while construct can be used to jump to a break condition. Accordingly, the data processing system 205 can identify at least some loops using a representation of the input instructions 210, such as an abstract syntax tree (AST). For example, the data processing system 205 can include a parser 206 to tokenize the input instructions 210 and build the AST using the tokenized representation of the input instructions 210.

To identify loops in the input instructions 210, the data processing system 205 can use control flow analysis or data flow analysis for the AST for the received input instructions 210. For example, a component of the data processing system 205 receive an AST for the input instructions 210 as generated by another component of the data processing system 205 (or another source). The generated AST can include a flat structure. For example, the data processing system 205 can generate a structured AST, and use the structured AST to create a flat version of the AST. The data processing system 205 can use the flat version of the AST to identify one or more loops represented by the AST for the input instructions 210 (e.g., one or more latent loops or one or more loops including a loop construct).

Referring further to data flow analysis for the AST, the data processing system 205 can identify various reducible instructions in the input instructions 210, as represented in the AST, and cause the code emitter 208 to generate the reduced instructions. For example, the data processing system 205 can identify redundant expressions for pruning (so that n lambda expressions or loops translatable to expression via a lambda expression can be pruned to 1 lambda expressions). Moreover, the reducible instructions can include instructions identified as having no effect on data flow, which can be pruned to zero instances in the output. The data processing system 205 can identify nested lambdas which are small (e.g., having a number of branches, layers, variable references or assignments, or so forth less than a corresponding threshold). The code emitter 208 of the data processing system 205 can output such expressions in a non-lambda form (sometimes referred to as expanded) form, to avoid nesting or deep nesting (e.g., based on a nested number of recursions). In some embodiments, the data processing system 100 identifies the loop structure in the input instructions 210 from repeated instances of instructions without the presence of a language keyword (e.g., repeating five instances of instructions inline, rather than providing one loop structure with n=5 cycles). The data processing system 100 can identify the repeated instances of the instructions as a lambda candidate using the flat AST. Where the lambda candidate satisfies a corresponding threshold, the code emitter 208 can generate output instructions 215 to include one lambda expression to represent the repeated instances in the input instructions 210.

The data processing system 205 can identify lambda expressions and extra-lambda instructions that refer to the same data, where the extra-lambda expressions refer to instructions which may be outside of a loop identified as expressible via the lambda expression but refer to data assigned or otherwise referenced in the loop. The data processing system 205 can determine metrics for a combination of the expressions within such a loop and the further (extra-lambda) instructions, and cause the code emitter 208 to generate a lambda expression in the output instructions 215 including both of the expressions of the loop and the further instructions. For example, the data processing system 205 can determine metrics for the combination of the loop and the further instructions, and compare the metrics to corresponding criteria for lambda expression. If the lambda expression criteria are satisfied, the code emitter 208 can output a lambda expression including the loop instructions and the further instructions. If the lambda expression criteria are not satisfied, the data processing system 205 can determine metrics for the loop without the further instructions and compare such metrics to the lambda expression criteria to determine whether or not to output a lambda expression for the loop.

The data processing system 205 can determine that one or more identified loops satisfy a criterion for modification by a transformer 207 of the data processing system 205. Transformers 207 are sometimes referred to as rewriters, translators, analyzers, optimizers, or so on, without limiting effect. In some embodiments, a criterion can be received as a configuration parameter 220. The configuration parameters 220 can include or relate to any of various programming conventions. For example, such conventions can include stylistic changes, such as the implementation of guidelines for the use of tabs or spaces for the output instructions 215, or the enforcement of variable naming conventions. The conventions can include behavioral changes, such as memory management instructions. The instructions can include assignments configured to cause information to be stored on a stack or a heap, or other aspects of memory management (e.g., to protect private variables or avoid overflows).

Behavior can vary between input instructions 210 and output instructions 215. For example, input instructions 210 can be received from languages with automatic memory protection, and a target language can implement automatic memory protection (e.g., input instructions 210 can be intended for single threaded linear execution, as may vary from a target environment). Lambda expressions can be implemented to provide to stylistic or behavioral changes to the input instructions 210. For example, the criterion for modification can include a criterion for lambda representation in output instructions 215. Accordingly, the application of the conventions for the generation of lambda expressions can improve readability of a codebase, or reduce memory usage, reduce context switches, or so forth.

The configuration parameters 220, or other programming conventions for the output instructions 215 can include thresholds for a quantity of variables referenced or assigned within each of the one or more identified loops. Such criteria can vary according to an input language, an output language, a presence or type of a loop construct (e.g., criteria can vary between latent loops and loop construct defined loops), or various further configuration parameters 220. For example, the further configuration parameters 220 can include a total or available stack or heap memory, configuration operations configured to increase execution speed or reduce memory usage, whether a variable is used outside of the loop, whether a loop is nested in a further loop (or a nested level) or any of various further inputs.

The configuration parameters 220 can be received by components of the data processing system 205 according to various input mechanisms. For example, the configuration parameters 220 can be received in a configuration file, selected via a graphical user interface, assigned based on an organization associated with the input or output instructions, selected based in an input or target language, or so forth. In some embodiments, a configuration parameter 220 can be hardcoded into one or more components of the data processing system 205. The transformer 207 can decorate a loop head to indicate an identified loop, a type of the identified loop (e.g., latent or loop construct defined) and, for each identified loop, any of various metrics. For example, the metrics can include a quantity of referenced variables, a quantity of assigned variables, or further indications of evaluated criteria. The decorated loop heads can refer to inline comments in a representation of the input instructions 210 (e.g., the flat or structured AST), or another indication for the loop heads accessible to the data processing system 205. The transformer 207 of the data processing system 205 can determine, for at least one loop, that a count of the quantity of the referenced or assigned variables meets a corresponding threshold for which to generate a lambda expression.

The data processing system 205 can include a code emitter 208 to generate output instructions 215 based on the input instructions 210 and the configuration parameters 220. For example, the code emitter 208 can ingest a representation of the AST, as modified by the transformer 207 (e.g., to include the loop head annotations), and generate the output instructions 215 to represent the modified AST. The output instructions 215 can (but need not) be provided in a different language relative to the input instructions 210. For example, the data processing system 205 can operate as a transpiler to generate output instructions 215 including lambda expressions based on input instructions 210 received in a language lacking support for (or usage of) lambda expressions.

Some example of output instructions 215 follow. Output instructions 215 can be provided in any of various languages. For example, data processing systems 205 can include multiple code emitters 208 corresponding to the different languages, as may be selected via a receipt of a configuration parameter 220. Example language can include, for example, various scripting, application, or other user languages such as Python, Rust, Go, TypeScript, and so on. Referring more particularly to the following examples, example two provides an indication of a Python output omitting a lambda expression. Example three provides an indication of a Python output including a lambda expression. As is apparent, example 3 avoids creation of a one-time use function and one-time use variable, as may make reading a large codebase challenging (e.g., the codebase can include further functions and assignments such as square_2, square_temp, and so forth).

### Example 2

$$numbers = [ 1 , 2 , 3 , 4 ]$$

$$def square ( x ) : return x * x$$

$$squares = list ( map ( square , numbers ) )$$

### Example 3

$$numbers = [ 1 , 2 , 3 , 4 ]$$

$$squares = list ( map ( lambda x : x * x , numbers ) )$$

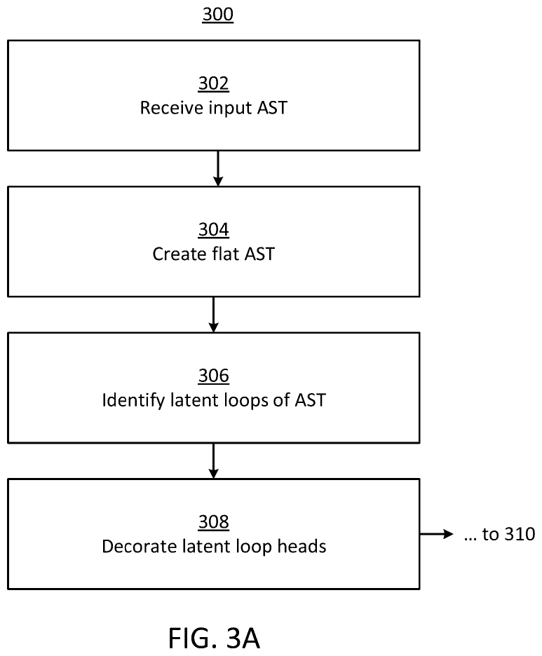

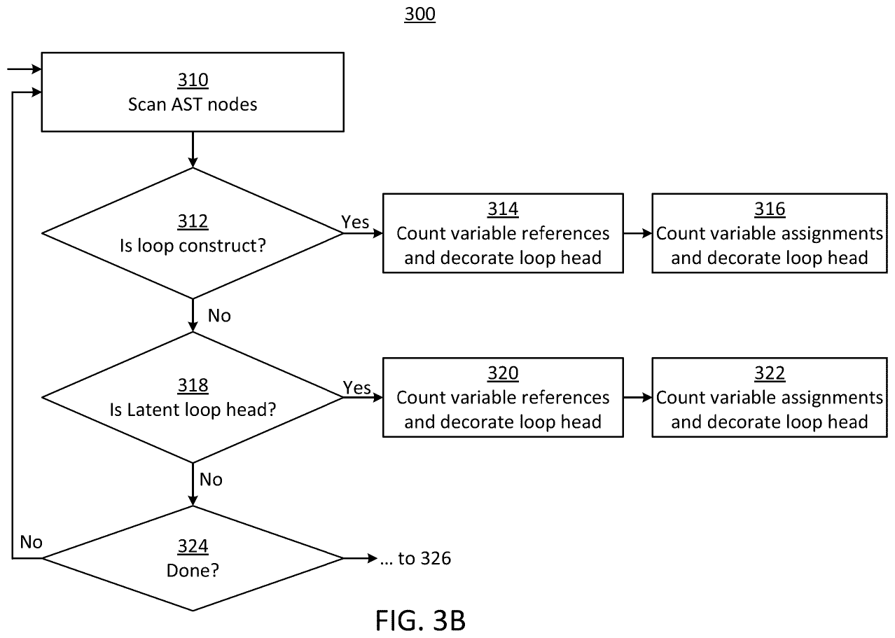

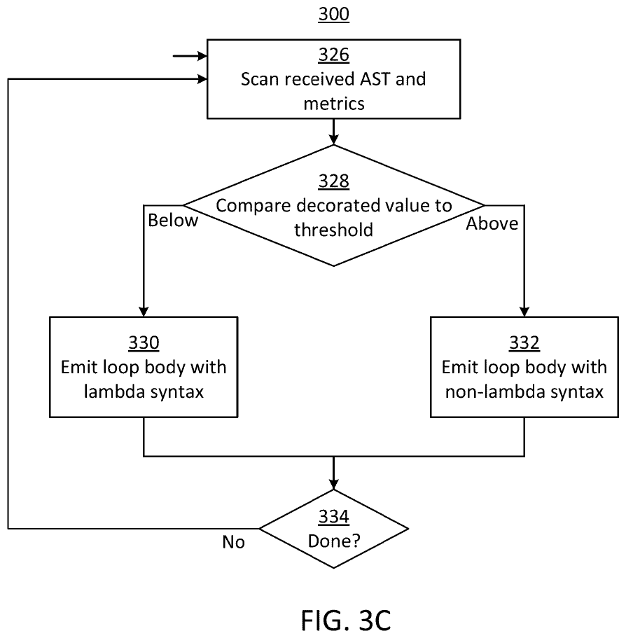

Referring to FIGS. 3A-3C, details of the design and operation of a method 300 for lambda identification are provided. At operation 302 of FIG. 3A, an input is received by the data processing system 205. For example, the input can include a set of executable instructions as may be received by the parser 206. The input can be received as a user level language, flat or structured AST, machine code, or according to any of various further representations. For example, the parser 206 can determine the hierarchy of the tree based on loop initiating statements and functions in the set of executable instructions. The tree can include expression nodes for assignment statements or other references of variables. At operation 304, the parser 206 can create a flat version of the received or generated AST. To create the flat AST, the parser can linearize the structured AST structure into a sequential list of operations or expressions. Branches of the structured AST structure can be preserved according to control flow operations, such as for, while, branches, or jumps, according to a selected target language and configuration parameters for the target language. The flat version of the AST can simplify subsequent operations, including identification of any loops or generation of sequential output of code.

At operation 306, the parser 206 can identify loops in the AST (e.g., the flat AST). The identified loops can include latent loops which may omit a loop construct such as for or while. According to some implementations, the identification of the loops can further identify loops including a loop construct. For example, identification of a back edge in a control flow graph for the flattened AST can identify latent and other loops. The parser 206 can decorate identified loop heads. For example, the decoration can include an indication of a loop or a type of loop.

The operations of the present disclosure can be executed iteratively with other operations. For example, the parser 206 can perform a depth-first traversal of the AST at operation 302, count a number of statements at each hierarchy level at operation 306, and decorate corresponding loop heads at operation 308. Subsequent to such an operation, the method 300 can identify further loop constructs. For example, a depth first search operation can precede a breadth first search operation, or the breadth first search operation can precede the depth first search operation.

Referring now to FIG. 3B, at operation 310, the parser 206 can scan nodes (e.g., lines) if the AST (e.g., the flat AST) for loops. Operation 310 can be performed as an iterative operation, for various loops of an AST, determining whether the scan of the AST is complete at operation 324 and advancing to operation 326 responsive to determining that the scan is complete at operation 324.

The scanning can include a scanning for the previous decorations, or other indications of a loop, such as a presence of a loop construct, including a for or while construct (e.g., operation 312). However, identified loop constructs may not indicate a presence of a loop, such where such a loop is not indicated according to a control flow graph. Such loops constructs can maintain placeholder logic, debug entry points, or other uses of loop constructs which may not be indicated via the control flow graph as a loop. The parser 206 can omit decorating loop heads associated with these constructs, or decorate the loop heads to prevent the generation of corresponding lambda expressions. Moreover, in some instances, the parser 206 is configured to identify the loop construct defined loops (operation 312) prior to an identification of latent loops at operation 318, so as to discriminate therebetween in the decoration of the respective loop heads. The data processing system 100 can use a dominator or other algorithm to identify loops in a flattened list representation of the AST, at either of operations 306 or 310. The configuration settings can include different criteria for loop construct defined loops and latent loops, as may be implemented by subsequent operations of the present method 300.

The decorations can include an indication of a count of variable usage in the loops, or the parser 206 can otherwise identify such a count. For example, for the loop-construct defined loops, the parser 206 can count a number of variable references at operation 314 and a number of variable assignments at operation 316. Such operations can include identifying assignment or other statements referencing a variable, such as by generating a flattened sequential list of the assignment statements and counting a number of occurrences of references and assignments.

With regard to the latent loops, the parser 206 can count a number of variable references at operation 320 and a number of variable assignments at operation 322. In some cases, the parser 206 may not distinguish between latent and construct-defined loops. That is, operation 314 may be coextensive with operation 320, and operation 316 may be coextensive with operation 322. Such a case can refer to a parser 206 being hardcoded to handle a specific construct, or to one that adapts its behavior based on the receipt of a configuration parameter 220. Moreover, in some cases, the parser 206 may not distinguish between a count of the assignments and a count of the variables. That is, operation 314 may be coextensive with operation 316, and operation 320 may be coextensive with operation 322. Again, such a case can refer to a parser 206 being hardcoded to handle a specific construct, or to one that adapts its behavior based on the receipt of a configuration parameter 220. The parser 206 can determine further counts, ratios, or other metrics. For example, the parser can determine a number of lines of code, number of abstract nodes, or nesting depth, as may be compared to corresponding thresholds to determine for which to generate a lambda expression. The parser 206 can provide the metrics to a transformer 207 to implement various transforms in the received AST. The transforms can include at least the lambda expression substitution. For example, the metrics can be provided as loop head decorations of a flat AST.

Referring now to FIG. 3C, at operation 326, the transformer 207 can scan the received AST and the metrics. The transformer 207 can compare the metrics to corresponding threshold values at operation 328. For example, the transformer 207 can compare a total count of multiple metrics to a total threshold, or a count of a particular metric to a threshold for that metric. Some examples of particular metrics can include, for example, a number of variable assignments or a number of variable references. A total metric can include multiple metrics or sums thereof, such as a sum of the number of variable assignments and the number of variable references. Various of the thresholds can depend on configuration parameters 220, as may vary according to a type of the second programming language. For example, some languages, such as Kotlin can support a larger number of variable references or assignments relative to other languages, such as scripting languages (e.g., Python). Such variance can correspond to code readability, behavioral operation, or operating performance (e.g., memory usage). The thresholds can further vary according to whether a loop is identified as a latent of construct defined loop.

Responsive to determining that one or more counts meets a corresponding threshold, the method 300 can proceed to operation 330. For such a determination, the transformer 207 can cause the code emitter 208 to generate a loop body as a lambda expression. For example, the transformer can provide a further decoration, inline instruction, or further data structure mapped to the AST to indicate whether the code emitter 208 should generate a lambda expression. In some embodiments, the language emitter 208 can emit a lambda invocation prefix and delegate further code generation to a lambda body syntax generator to emit the body of the lambda expression. In some instances, the language emitter 208 can generate a lambda expression including variables which are not local to the lambda expression. The language emitter 208 can use a global dictionary to maintain a state of these variables throughout one or more output files. In some instances, the language emitter 208 can generate a lambda expression omitting global variables, as may ease maintaining closure of the lambda function.

Like other functions, the code emitter 208 can generate a closure representation for any generated lambda expressions. The closure can include the lambda expression itself, along with any variables passed to or from the lambda expression (sometimes referred to as captured variables). The data processing system 100 can maintain variables that are captured by the closure and their impact on any subsequent lambda invocations. The data processing system 100 can further track the creation of closures and their invocations incident to control flow analysis. This tracking can be performed using as flow-sensitive analysis or flow-insensitive analysis. In flow sensitive analysis, coherence of order of execution of lambda expressions is not maintained. Omitting such sequential coherence may lower precision, but can reduce computational load, especially for large codebases, where maintenance of coherence can accumulate exponentially. In flow sensitive analysis, coherence of order of execution of lambda expressions is maintained, as may improve precision. Some illustrative examples of flow-analysis include Hindley-Milner type systems, as may be used for type inferenced in some output languages including Haskel or Meta-Language. Type systems can reduce computational load by constraining the possible flow of control based on type information, reducing the complexity of the analysis. Some languages use effect systems that track the effects of lambda expressions, such as state changes or I/O operations. These systems can aid flow analysis by providing additional information about how lambdas affect a control flow.

Aspects of code emission can use variable control flow analysis techniques to reduce closure complexity at compile time. Just-In-Time (JIT) compilers, such as those used in JavaScript engines, can use control flow analysis to predict generation of lambda expressions at runtime. This can aid faster execution of functional code by predicting which lambdas might be invoked and optimizing them accordingly. The code emitter 208 can further use control flow analysis to identify dead code, reduce unnecessary allocations (e.g., for closures), or inlining some lambdas for performance improvements of programs including lambda expressions. The lambdas identified for inlining can be identified according to a comparison of various metrics to a corresponding threshold. Such metrics can include a number or depth of an AST representation, a number of variables, type of variables, number of variable references or assignments, or so forth. Further, other metrics of the present disclosure can be performed with these or further metrics still.

Responsive to determining that one or more counts does not meet a corresponding threshold, the method 300 can proceed to operation 332, where the code emitter 208 does not generate the lambda expression. For example, at operation 332, the code emitter 208 can generate a distinct function name to implement the loop. Upon completion of operation 330 or 332, the method 300 can determine whether the code generation is complete at operation 334 (e.g., whether the transformer 207 has reached an end of file). Where no EOF is indicated, the method 300 can return to operation 326. Where an EOF is indicated, the method 300 can complete (e.g., terminate code generation), or proceed to further operations to refine the generated code.

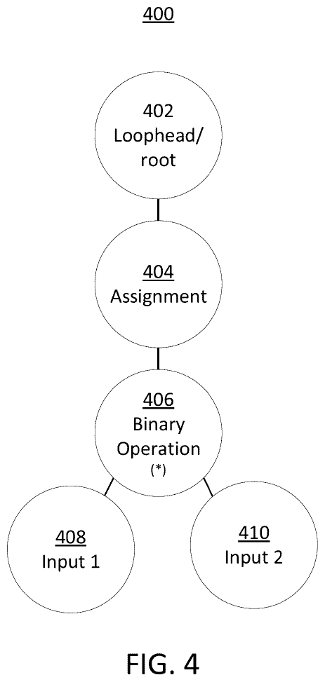

Referring now to FIG. 4, a structured AST 400 is provided, corresponding to the executable instructions of examples 1-3. A root 402 of the AST 400 can include a loop identifier detected in received executable instructions, as demarcated as a loop head. For example, a loop head can refer to the procedure block of Example 1. A first level branch 404 of the AST 400 includes an assignment of a variable x, where x is assigned to realize an assignment count of one. A second level branch 406 of the AST 400 includes a binary multiplication operator for operand nodes of the third level to generate an output product. Each of two third level branches 408, 410 reference the previously assigned variable, so that a resultant count for variable references is 2. These branches reference the variable, x, as each of a multiplicand and a multiplier.

The parser can generate a flat representation of the AST 400 as follows:

| | |
|---|---|
| 1: | { “op”: “param”, “name”: “x” }, |
| 2: | { “op”: “load_param”, “src”: “x”, “dest”: “r1” }, |
| 3: | { “op”: “load_param”, “src”: “x”, “dest”: “r2” }, |
| 4: | { “op”: “mul”, “left”: “r1”, “right”: “r2”, “dest”: “r3” }, |
| 5: | { “op”: “assign_var”, “name”: “t1”, “src”: “r3” }, |
| 6: | { “op”: “return”, “value”: “t1” } |

As indicated above, the variable assignment (param) and references (load_param) are more atomically defined, as may ease their identification The data processing system 205 can identify a count of 1 variable assignment from line 1, according to a match of the parameter declaration (param). The data processing system 205 can identify a count of 1 variable reference from line 2, according to a match of the parameter access (load_param). Similarly, the data processing system 205 can identify an additional count of 1 variable reference (for a total of two) from line 3. Such counts, like other metrics, can be compared to corresponding thresholds for which to generate a lambda expression, as may be used to generate example 2 and example 3, above. For example, the data processing system 205 can generate example 2 (omitting the lambda expression) responsive to determining that the count does not meet a corresponding threshold or generate example 3 (including the lambda expression) responsive to determining that the count meets a corresponding threshold.

While the invention has been particularly shown and described with reference to specific embodiments, it should be understood by those skilled in the art that various changes in form and detail may be made therein without departing from the spirit and scope of the invention described in this disclosure.

Various descriptions, herein, make use of the word “or” to refer to plurality alternative options. Such references are intended to convey an inclusive or. For example, various data processing system components herein are referred to as hardware or software components. Such a disclosure indicates that the components may comprise a hardware component, a software component, or both a hardware and software components.

What is claimed is:

1. A system comprising one or more processors coupled with memory, the one or more processors configured to execute computer readable instructions to:
receive an abstract syntax tree (AST) of a set of executable instructions in a first programming language;
identify, using the AST, one or more loops represented by the AST for the set of executable instructions;
identify, for each of the one or more loops, a count of a number of variables referenced or assigned for each of the one or more loops;
determine, for a loop of the one or more loops, that the count meets a threshold for which to generate a lambda expression in a second programming language for the loop; and
generate, by the one or more processors based at least on the determination, a second set of executable instructions in the second programming language comprising the lambda expression to represent the loop.

2. The system of claim 1, wherein the one or more processors are further configured to:
create a flat version of the AST; and
use the flat version of the AST to identify the one or more loops.

3. The system of claim 1, wherein the threshold is determined based at least on a type of the second programming language.

4. The system of claim 1, wherein the one or more processors are further configured to:
determine whether each loop of the one or more loops is a latent loop or is identified by a loop construct of the first programming language.

5. The system of claim 4, wherein the threshold is determined based at least on whether the loop is the latent loop or is identified by the loop construct.

6. The system of claim 1, wherein the one or more processors are further configured to:
decorate a loop head in the AST upon identifying the one or more loops, the decoration comprising an indication of a loop type of a plurality of loop types, wherein the generation of the lambda expression is based at least on the loop type.

7. The system of claim 1, wherein:
the count comprises a number of variable assignments.

8. The system of claim 1, wherein:
the count comprises a number of variable references.

9. A method comprising:
receiving, by one or more processors, an abstract syntax tree (AST) of a set of executable instructions in a first programming language;
identifying, by the one or more processors using the AST, one or more loops represented by the AST for the set of executable instructions;
identifying, by the one or more processors for each of the one or more loops, a count of a number of variables referenced or assigned for each of the one or more loops;
determining, by the one or more processors for a loop of the one or more loops, that the count meets a threshold for which to generate a lambda expression in a second programming language for the loop; and
generating, by the one or more processors based at least on the determination, a second set of executable instructions in the second programming language comprising the lambda expression to represent the loop.

10. The method of claim 9, further comprising:
creating a flat version of the AST; and
using the flat version of the AST to identify the one or more loops.

11. The method of claim 9, wherein the threshold is determined based at least on a type of the second programming language.

12. The method of claim 9, further comprising:
determining, by the one or more processors, whether each loop of the one or more loops is a latent loop or is identified by a loop construct of the first programming language.

13. The method of claim 12, wherein the threshold is determined based at least on whether the loop is the latent loop or is identified by the loop construct.

14. The method of claim 9, further comprising:
decorating a loop head in the AST upon identifying the one or more loops, the decoration comprising an indication of a loop type of a plurality of loop types, wherein the generation of the lambda expression is based at least on the loop type.

15. The method of claim 9, wherein:
the threshold comprises a threshold number of variable assignments.

16. The method of claim 9, wherein:
the threshold comprises a threshold number of variable assignments.

17. A non-transitory computer-readable medium comprising computer-readable instructions stored thereon that when executed by one or more processors of a data processing system cause the one or more processors to:
create a flat version of a received abstract syntax tree (AST) of a set of executable instructions in a first programming language;
identify, using the flat version of the AST, one or more loops represented by the AST for the set of executable instructions;
identify, for each of the one or more loops, a count of a number of variables referenced or assigned for each of the one or more loops;
determine, for a loop of the one or more loops, that the count meets a threshold for which to generate a lambda expression in a second programming language for the loop; and
generate, by the one or more processors based at least on the determination, a second set of executable instructions in the second programming language comprising the lambda expression to represent the loop.

18. The computer-readable medium of claim 17, wherein the computer-readable instructions comprise instructions to:
determine whether each loop of the one or more loops is a latent loop or is identified by a loop construct of the first programming language, wherein the threshold is determined based at least on whether the loop is the latent loop or is identified by the loop construct.

19. The computer-readable medium of claim 17, wherein the threshold is determined based at least on a type of the second programming language.

20. The computer-readable medium of claim 17, wherein:
the count comprises a number of variable assignments and a number of variable references.
